(19) United States
(12) Patent Application Publication
(10) Pub. No.: US 2024/0309981 A1
(43) Pub. Date: Sep. 19, 2024

(54) METHOD AND DEVICE FOR MANUFACTURING A PIPE T-BRANCH

(71) Applicant: Leo LARIKKA, VANTAA (FI)

(72) Inventor: Leo LARIKKA, VANTAA (FI)

(21) Appl. No.: 18/580,351

(22) PCT Filed: Jun. 17, 2022
(86) PCT No.: PCT/FI2022/050430

§ 371 Date: Jan. 18, 2024

(30) Foreign Application Priority Data
Aug. 26, 2021 (FI) 20215898

(51) Int. Cl. F16L 41/02; B21D 28/02; B23K 9/02

(52) U.S. Cl. CPC F16L 41/021; B21D 28/02; B23K 9/0216

(57) ABSTRACT

The object of the invention is a method and a device for making a pipe T-branch by connecting the shaped end of a branch pipe with internal welding to the edges of a hole in a main pipe. The hole in the main pipe (T) and the arcs corresponding to the main pipe at the end of the branch pipe (P) are cut mechanically by removing one solid part from the hole and two (22) solid parts from the end of the branch pipe in a dry mechanical process, wherein the cleanliness of the joint areas remains suitable for welding. The shaped end of the branch pipe (P) is placed around the hole in the main pipe and the joint seam (21) between the pipes is welded by internal welding without the use of a welding filler. A suitable branching hole is made by punching tangentially from the side of the main pipe such that the tangent of the pipe, which is parallel to the direction of movement of the punch tool, is located inside the punch tool (1).

The object of the invention is a method and a device for making a pipe T-branch by connecting a shaped end of the branch pipe to the edges of a hole in the main pipe by internal welding.

Another object of the invention is a device that can be used for making the hole in the main pipe as required in the method.

The end of the branch pipe is cut into an arc matching the main pipe using a method and device known from e.g. patent publication U.S. Pat. No. 10,537,948, with the exception that the cutting depth of the parts to be removed from the end of the branch pipe (P) is adjusted so as to provide an uncut straight end surface at the end of the branch pipe between the arcs corresponding to the main pipe, as shown in FIG. 4. This allows for an appropriate amount of material to be left at the outer face of the main pipe for welding the parts together from the inside without having to introduce filler material from the outside.

There are many ways to make a hole in a pipe for a branch connection when making a T-branch of the pipe. For smaller pipes, the most common method is drilling. Drilling produces chips and for the drilling to be efficient, the use of cutting fluid is required. The chips and the fluid present a disadvantage in production and for the environment, because for joint welding, the chips must be removed and the parts cleaned, typically by washing with warm water. In addition, making a hole in a pipe by drilling is a relatively slow production method.

Publication CA 2280650 discloses a method of making a hole in a curved pipe of an engine exhaust manifold by punching. The punch tool is guided in such a way that the outside of the punch tool is tangential to the outer surface of the pipe. The punched hole is expanded using a mandrel with segmented fingers. Finally, the hole is equipped with a thread to which a metal pipe equipped with a sensor can be installed. The design of the tip of the punch tool and the lack of an internal support do not allow making a hole suitable for making a T-branch. The shape of the resulting hole is not suitable for connecting the shaped end of a branch pipe by internal welding.

Publication JP 2001162335 A discloses a method for making a hole in a pipe such that a punch tool tangentially penetrates a part of the circumference of the pipe and removes the substance pushed by the flat front end of the blade from the circumference of the pipe. The beveled part of the blade displaces the removed material from the hole. The shaping of the blade upsets the material to be removed and causes deformation in the pipe, particularly as the non-expansible inner support does not sufficiently support the edges of the hole at the impact points of the punch tool. A hole formed in this way is not suitable for connecting the shaped end of a branch pipe by internal welding. This applies particularly to larger branch pipe diameters, as the method described is not suitable for making holes with diameters close to the diameter of the pipe to be perforated. This unsuitability is due to the shaping of the blade being such that it upsets the material and the non-expansible inner support not preventing the pipe from deforming.

Publication U.S. Pat. No. 3,120,143 discloses a method for making a hole in a pipe by punching tangentially for connecting a T-branch. The cutting blade of the punch tool pierces the pipe first at one edge of the hole formed from the outside in, and then at the opposite edge of the hole formed from the inside to the outside of the pipe. The punch tool has a tapered, sharp-pointed blade, which is only suitable for use in thin-walled pipes and soft pipe materials. Such a blade will not withstand piercing steel pipes with a typical wall thickness. In addition, it lacks support on the inside of the pipe, causing the pipe to deform to such extent that the method is not suitable for making a T-branch joint.

The simplest way to make a hole suitable for making a T-branch is the typical punching method, wherein the hole is punched perpendicularly to the longitudinal axis of the pipe using a round punch tool. This works when the branch pipe is smaller than the main pipe by a certain amount. For making a hole in the pipe to which a branch the size of or almost the size of the pipe itself can be connected, the typical punch and die solutions do not work. The differences between the inner edge of the end of the branch pipe and the inner edge of the punched hole are so large that internal welding is not possible, and external welding does not produce an acceptable result from a flow quality perspective.

The purpose of the invention is to provide a method and a device enabling the mechanical steps for making the parts of the T-branch to be carried out as a “dry process” without cutting oils and washes, and for providing the main pipe with a hole to which a branch of the same size or almost the same size as the pipe itself can be connected.

The method according to the invention comprises cutting a hole in the main pipe (T) and arcs corresponding to the main pipe at the end of the branch pipe (P) mechanically by removing one solid part from the hole and two solid parts from the end of the branch pipe in a dry mechanical process, where the cleanliness of the joint areas remains suitable for welding, cutting a hole in the branch pipe with a punch tool that is moved tangentially with respect to the main pipe past the central axis of the main pipe, supporting the main pipe from the inside on both sides of the hole to be cut using an expansible inner support, placing the shaped end of the branch pipe (P) around the hole in the main pipe and welding the joint seam between the pipes with internal welding without the use of a welding filler.

Examples of the method and device for carrying out internal welding are presented in the publications U.S. Pat. No. 6,433,307 (B1), EP 1633520 (B1) and WO 2019166689. Based on these, a person skilled in the art knows how to make use of the invention as far as the internal welding feature is concerned.

In the device according to the invention, a specially constructed inner support is used to prevent deformation of the main pipe, such as buckling, when the punch tool penetrates the wall of the main pipe tangentially. The characteristic features of the device are presented in claim number 5.

Furthermore, the purpose of the preferred embodiments of the invention is to provide a method and a device with which the shape of the hole in the main pipe can be joined as closely as possible to the shape of the inner surface of the end of the branch pipe, and further wherein the thicknesses of the overlapping material at the joint seam are suitable for welding the parts together from the inside without having to introduce filler from the outside.

These additional purposes are achieved by the invention by means of the characteristic features presented in the dependent method and device claims.

When the diameter of the branch pipe is equal or almost equal to the diameter of the main pipe, it is preferred to shape the punch tool such that the cutting edge consists of an arc and two straight lines between which the arc is located. This allows for the shape of the hole to be joined as closely as possible to the shape of the inner surface of the end of the branch pipe. In such case, the impact surfaces of the two pipes have full thickness compared to the wall thickness of the pipe. In addition, the inner edge of the punched hole is left with a sharp-angled area of material, having almost uniform thickness on the sides of the hole created on the opposite sides of the punch tool, and to a lesser extent on the sides of the hole that are at a distance from each other in the longitudinal direction of the main pipe. This material acts as the filler in the internal welding. As a result, there is no material thinner than the base material in the joint area. Further, the joint area made with internal welding is of good flow quality.

Next, the invention is described by means of an exemplary embodiment with reference to the accompanying drawings, in which:

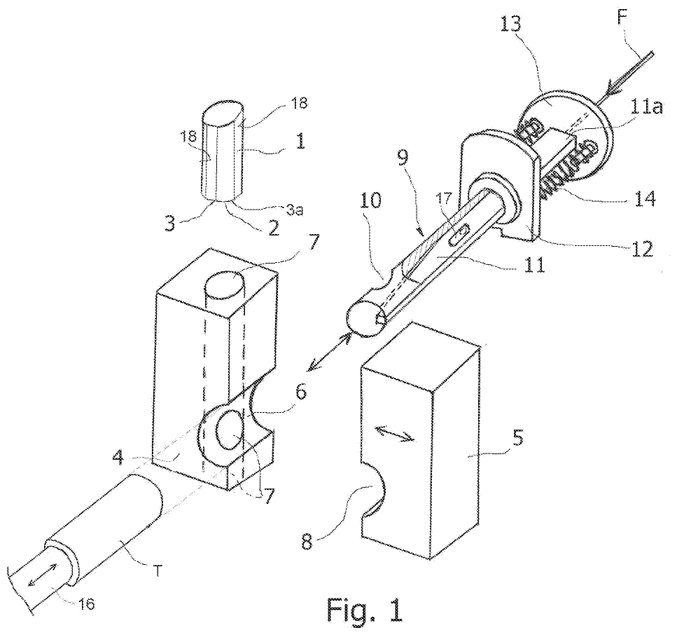

FIG. 1 shows the basic parts of the device used for carrying out the method according to the invention as an axonometric assembly view seen diagonally from above.

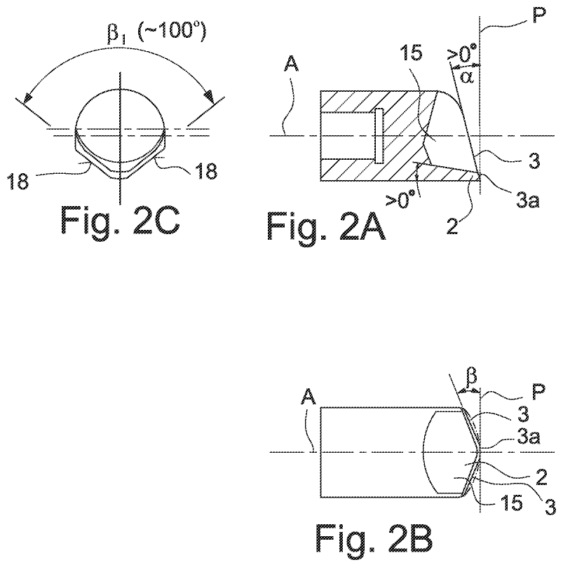

FIG. 2A shows a longitudinal section of the punch tool according to a preferred embodiment of the invention.

FIG. 2B shows the punch tool of FIG. 2A as seen from above.

FIG. 2C shows the punch tool of FIG. 2A as seen from the cutting blade end.

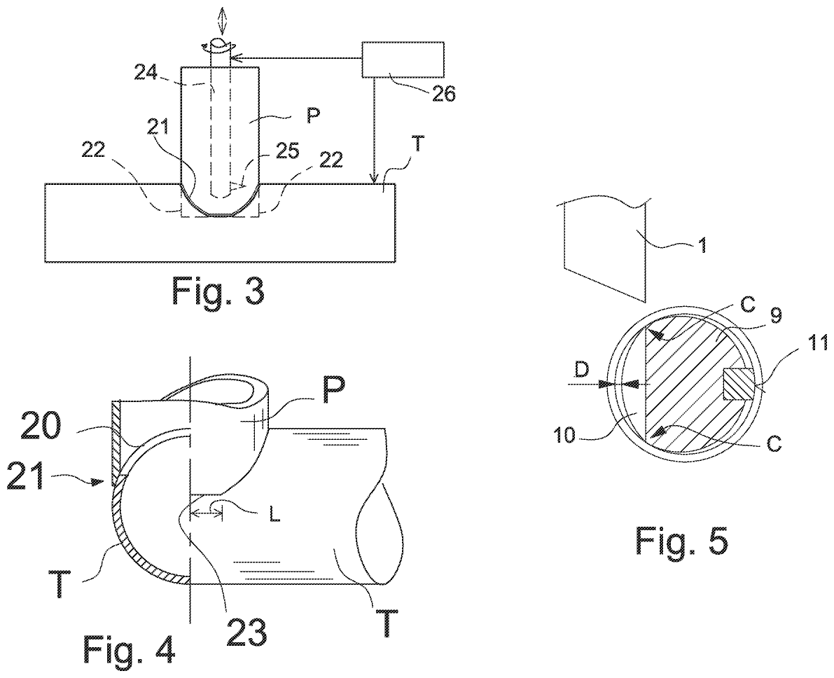

FIG. 3 shows a pipe T-branch manufactured using the method and device according to the invention.

FIG. 4 shows the pipe T-branch manufactured using the method and device according to the invention in more detail, with the left side of the center line cut and turned 90 degrees to the right.

FIG. 5 shows a cross-section of the inner support in its supporting position inside the main pipe.

The branching hole 20 is punched in the main pipe T using a punch tool 1 with an almost round cross-section. The cutting blade 3 of the punch tool 1 has a curved tip 3a and straight cutting edges on both sides thereof. The angle β1 between the straight cutting edges of the cutting blade 3 on opposite sides of the curved tip 3a of the cutting blade is between 97 and 107° when seen in the direction of the motion axis A of the punch tool (FIG. 2C). In the embodiment shown, the outer surface of the blade body 2 has two planar sides 18 ending in the straight cutting edges of the cutting blade 3. As mentioned above, this design of the punch tool allows for the shape of the hole to be joined as closely as possible to the shape of the inner surface of the head of the branch pipe when the branch pipe and the main pipe are of equal size. In such case, internal welding without a filler produces the desired wall thickness at the welding seam. When the size of the branch pipe decreases with respect to the main pipe, the planar sides 18 and the straight cutting edges are left out and the punch tool blank may be cylindrical. The half of the punch tool that does not participate in making the hole may be shaped relatively freely.

The pipe is supported from the outside during the punch with retaining jaws 4, 5. The retaining jaws 4 and 5 include support grooves 6, 8 for receiving the pipe to be perforated. The curvature of the support grooves matches the curvature of the outer surface of the main pipe T. In their position supporting the main pipe, the retaining jaws 4 and 5 remain slightly separated from each other. The second retaining jaw 5 can be moved back and forth so that the pipe can be placed between the retaining jaws 4 and 5 in a clamping grip by the grooves 6 and 8.

The first part 4 of the retaining jaws comprises a punch tool guide hole 7 receiving the punch tool 1 and having a longitudinal axis parallel to the direction of movement of the punch tool 1. The punch tool guide hole 7 is elongated and intersects with the support groove 6 in the first part 4 of the retaining jaws. The guide hole 7 extends past the support groove 8 in the second part 5 of the retaining jaws. In such case, the tangent of an imaginary cylinder coinciding with the surfaces of the support grooves 6, 8 in the pipe supporting position is located in the guide hole 7, parallel to the longitudinal axis of the guide hole. In other words, the tangent in question touches the outer surface of the pipe at the point where the branching hole is made. The punch tool guide hole 7 extends to both sides of the support groove 6 in the first part 4 of the retaining jaws.

The punch device further comprises an inner support 9 for supporting the main pipe T from the inside during punching. The inner support is necessary for preventing the main pipe from buckling in a cutting situation when the punch tool penetrates the wall. The inner support 9 must support the pipe close to the surface of the punch tool, i.e., the distance between the arc of the outer edge of the punch tool and the arc of the inner support should be minimal. A round inner support does not allow this. The inner diameter of different main pipes is not standard. The inner support must also fit in a pipe with negative tolerance, making it loose in others. In the invention, this problem has been solved by the design of an inner support that can be expanded by means of a wedge. FIG. 5 illustrates how the roundness of the inner support has been altered on the cutting side at point D such that the impact points with the inner surface of the pipe T are located at points C, which are at a functional clearance from the line of the path of the cutting edge of the punch tool 1. The inner support 9 is pressed against the inner surface of the main pipe with a wedge 11 at the impact points C. The impact points C with the inner surface of the main pipe coincide with the opposite ends of the curved recess 10 of the inner support as seen in the direction of movement of the punch tool 1.

The inner support 9 is arranged to be moved to and from the supporting position by a single actuator F arranged to first move the inner support 9 along with the wedge 11 to the supporting position via a wedge arm 11a and a spring 14. The force required for this movement is less than the force required to deform the spring 14 (compressing the compression spring) against the spring force, whereby the spring 14 acts like a fixed pin pushing a support flange 12 of the inner support 9 in front of it. The wedge arm 11a is attached to a push flange 13 moved back and forth by the actuator F. The actuator F is typically a piston cylinder device. In the example shown, two compression springs 14 are attached between the support flange 12 and the push flange 13. When the support flange 12 meets a fixed abutment in the frame (not shown), the actuator F moves only the wedge 11 via the wedge arm 11a against the force of the springs 14. In such case, the inner support 9 is retained in the supporting position by means of the support flange 12, whereby the inner support 9 is wedged into the supporting position. The wedge 11 comprises a slot 17 into which the pin of the inner support extends. By means of the slot 17 and the pin, the wedge can pull the inner support backwards out of the supporting position. During the wedging step, the slot 17 does not limit the movement between the inner support 9 and the wedge 11, which movement continues until the inner support is supported against the inner surface of the pipe with sufficient force. The punch tool 1 moves through the curved recess 10 in the inner support 9 when the inner support 9 is in place in the supporting position inside the pipe.

The cutting blade 3 of the punch tool 1 has a curved tip 3a and straight cutting edges on both sides thereof, and the blade 3 is beveled with respect to the normal plane (P) of the center line (A) of the punch tool such that the bevel angle α is greater than 0°, in which case the curved tip 3a of the cutting blade penetrates the pipe first from the side of the pipe during the punch.

The bevel and shape of the cutting blade 3 of the punch tool 1 are chosen such that the piece is removed from the pipe with a slit-like cut, while also minimizing the cutting length. The bevel angle α of the tip of the punch tool and likewise of the cutting blade 3 is typically between 5° and 30° with respect to the normal plane P of the center line A of the punch tool. The normal plane P is a plane passing through the tip 3a of the cutting blade 3 that is perpendicular to the center line A of the punch tool. The optimal bevel angle α depends on the material of the pipe to be perforated, and the dimensions and the size of the hole to be punched. In many cases, the preferred bevel angle α is between 10° and 25°, preferably around 15 to 20°. As seen in the plane of FIG. 2B, the angle β between the straight parts of the cutting blade 3 on opposite sides of the curved tip 3a of the cutting blade is typically between 15 and 25° depending on the magnitude of the angle α. This is also affected by the angle β1 between the straight cutting edges of the cutting blade 3 on opposite sides of the curved tip 3a of the cutting blade and the planar sides 18, being typically between 97° and 107° when seen in the direction of the longitudinal axis (A) of the punch tool. (FIG. 2C). This design allows for the durability of the punch tool to be improved and the material distribution at the edges of the hole to be rendered such that is optimally suited for internal welding without introducing filler from the outside.

Preferably, the punch tool 1 has a trough-like blade body 2 ending in a cutting blade 3. The outer surface of the blade body 2 has two planar sides 18 ending in the straight cutting edges of the cutting blade. The remainder of the outer surface of the blade body 2 may be cylindrical. The wall thickness of the blade body 2 increases when moving from the cutting blade 3 towards the base of the blade body 2. The base of the blade body 2 ends in a relieving pit 15 receiving the piece removed from the pipe. The punch tool 1 along with its cutting blade is made, for example, by cutting a cylindrical punch tool blank equipped with planar sides 18 to an angle of about 15 to 25°, for example, whereby the punch tool tip is formed into the shape shown in FIG. 2B, with an arcuate tip in the middle and straight blade edges on both sides. This design reduces the punching force and improves the durability of the punch tool. FIG. 2B shows the ellipse arc (dot-and-dash line) formed by the bevel cut in a case where the punch tool would be round. In this case, the impact point with the pipe wall would be too blunt. The straight blade edges make the impact point sharper. The tip 3a of the cutting blade 3 is arranged to penetrate the pipe first from the side of the pipe during the punch. The tip 3a thus prevents the pipe from rotating along with the pushing movement of the punch tool 1, so that the clamping force of the retaining jaws 4 and 5 against the outer surface of the pipe may be smaller.

For making the branching hole in the pipe, the punch tool 1 is guided using the guide hole 7 to travel tangentially with respect to the pipe between the outer surface and the center line of the pipe. Tangentiality herein means that the tangent of the pipe, which is parallel to the direction of movement of the punch tool, is located inside the punch tool 1. In other words, the punch tool is moved tangentially with respect to the main pipe past the central axis of the main pipe. In this case, the cutting blade 3 of the punch tool pierces the pipe first at one edge of the hole formed from the outside in, and then at the other, opposite edge of the hole formed from the inside to the outside of the pipe. Between the punches, the cutting blade 3 of the punch tool cuts the sides of the hole 20 at the opposite sides of the punch tool.

FIG. 4 illustrates the shaping of the end of the branch pipe P in such a way that it is optimally suited to be connected by internal welding to the hole 20 formed as described hereinbefore. The cutting depth of the parts to be removed from the end of the branch pipe P is adjusted so as to provide an uncut straight end surface 23 at the end of the branch pipe between the arcs corresponding to the main pipe. This allows for obtaining an optimal amount of material at the joint to be melted during welding.

Using the device described above, a hole can be cut in the main pipe by the following method steps:
inserting the main pipe in its axial direction between the retaining jaws 4, 5 to the main pipe (T) perforating position;
fastening the retaining jaws 4, 5 to the main pipe to hold the main pipe in the perforating position;
moving the inner support 9 and the wedge 11 comprised in the inner support inside the main pipe;
stopping the movement of the inner support 9 in such a position that the curved recess 10 in the inner support is located on the path of the punch tool 1 at the hole to be formed in the main pipe;
continuing the movement of the wedge 11 with respect to the inner support 9 in order to press the inner support against the inner wall of the main pipe (T) on both sides of the recess 10;
guiding the punch tool 1 to travel tangentially with respect to the pipe between the outer surface and the center line of the pipe such that the tangent of the pipe, which is parallel to the direction of movement of the punch tool, is located inside the punch tool 1, whereby the cutting blade 3 of the punch tool first pierces the main pipe at one edge of the hole formed from the outside in and then at the opposite edge of the hole formed from the inside to the outside of the main pipe;
moving the wedge 11 in the direction opposite to the previous direction of movement in order to release the inner support 9 from the pressure against the inner surface of the main pipe;
moving the inner support 9 and the wedge 11 out of the main pipe;
opening the retaining jaws 4, 5 and allowing the perforated main pipe fall into a collection container.

The perforated pipe must be removed from the retaining jaw 4 with a special remover (not shown).

Thus, the punch tool is used to remove one solid part from the wall of the main pipe directly outside the pipe. Two curved pieces are also removed from the end of the branch pipe P by punching, wherein the curvature of the cut surface of the two curved pieces matches the curvature of the outer surface of the main pipe. Finally, the shaped end of the branch pipe (P) is placed around the hole 20 in the main pipe and the joint seam 21 between the pipes is welded with internal welding without the use of a welding filler by fusing together the materials at the overlapping joint edges. FIG. 3 shows an electrode arm 24 and an electrode 25, the tip of which is guided along a path following the joint seam 21 by rotating the electrode arm while moving it back and forth. A power source 26 is used to cause a voltage between the electrode 25 and the pipes. The voltage is adjusted to a suitable level so that the electric arc between the electrode 25 and the joint seam fuses the materials at the joint seam 21 into a unified wall joining the walls of the pipes T and P.

1. A method for making a pipe T-branch by connecting the shaped end of a branch pipe by internal welding to the edges of a hole in a main pipe, the method comprising cutting the hole in the main pipe (T) and the arcs corresponding to the main pipe at the end of the branch pipe (P) mechanically by removing one solid part from the hole and two (22) solid parts from the end of the branch pipe in a dry mechanical process, wherein the cleanliness of the joint areas remains suitable for welding, cutting the branch pipe hole with a punch tool (1) moved tangentially with respect to the main pipe past the central axis of the main pipe, supporting the main pipe from the inside with an expansible inner support (9, 10, 11) on both sides of the hole to be cut, placing the shaped end of the branch pipe (P) around the hole (20) in the main pipe and welding the joint seam (21) be-tween the pipes by internal welding without the use of a welding filler.

2. The method according to claim 1, wherein the hole in the main pipe is cut by the following method steps:
inserting the main pipe in its axial direction between the retaining jaws (4, 5) to the main pipe (T) perforating position,
fastening the retaining jaws (4, 5) to the main pipe to hold the main pipe in the perforating position;
moving the inner support (9) and the wedge (11) comprised in the inner sup-port inside the main pipe;
stopping the movement of the inner support (9) in such a position that the curved recess (10) in the inner support is located on the path of the punch tool (1) at the hole to be formed in the main pipe;
continuing the movement of the wedge (11) with respect to the inner support (9) in order to press the inner support against the inner wall of the main pipe (T) on both sides of the recess (10);
guiding the punch tool (1) to travel tangentially with respect to the pipe between the outer surface and the center line of the pipe, so that the tangent of the pipe, which is parallel to the direction of movement of the punch tool, is located inside the punch tool (1), whereby the cutting blade (3) of the punch tool pierces the main pipe first at one edge of the hole formed from the outside in, and then at the opposite edge of the hole to be formed from the inside to the outside of the main pipe;
moving the wedge (11) in the direction opposite to the previous direction of movement in order to release the inner support (9) from pressure against the inner surface of the main pipe;
moving the inner support (9) and the wedge (11) out of the main pipe;
opening the retaining jaws (4, 5) and allowing the perforated main pipe fall into a collection container.

3. The method according to claim 2, characterized in that the cutting depth of the parts to be removed from the end of the branch pipe (P) is adjusted so as to provide an uncut straight end surface (23) at the end of the branch pipe between the arcs corresponding to the main pipe.

4. The method according to claim 2, characterized in that the inner support (9) is pressed against the inner surface of the pipe with a wedge (11), which is moved back and forth in relation to the inner support (9) by the same actuator (F) with which the inner support (9) is moved to and from the supporting position, and in that the inner support (9) along with its wedge (11) is first moved to the supporting position via a wedge arm (11a) and a spring (14) and then to the supporting position by moving only the wedge (11) via the wedge arm (11a) against the force of said spring (14).

5. A device for making a branching hole in a pipe using the method according to claim 2, the device comprising a punch tool (1) having a round or nearly round or partly round cross-section, a cutting blade (3) at the end of the punch tool, retaining jaws (4, 5) for supporting the pipe from the outside during the punch, the retaining jaws comprising support grooves (6, 8) for receiving the pipe to be perforated, a punch tool guide hole (7) receiving the punch tool (1) in the first part (4) of the retaining jaws, wherein the guide hole (7) has a longitudinal axis parallel to the direction of movement of the punch tool (1) and the guide hole (7) is elongated and intersects with the support groove (6) in the first part (4) of the retaining jaws and extends past the support groove (8) in the second part (5) of the outer support, whereby the tangent of an imaginary cylinder coinciding the surfaces of the support grooves (6, 8) in the pipe supporting position is located in the guide hole (7) in a position parallel to the longitudinal axis of the guide hole, and the punch tool guide hole (7) extends to both sides of the support groove (6) of the first part of (4) of the outer support, and an inner support (9) for supporting the pipe from the inside during the punch, characterized in that the inner support (9) comprises a wedge (11) arranged to press the inner sup-port (9) against the inner surface of the pipe, and in that the inner support (9) comprises a curved recess (10) through which the punch tool (1) is arranged to be moved when the inner support (9) is in place inside the pipe in the supporting position, wherein the inner support (9) is shaped in such a way that its impact points (C) with the inner surface of the main pipe coincide with the opposite ends of the curved recess (10) as seen in the direction of movement of the punch tool (1).

6. The device according to claim 5, characterized in that the blade (3) is beveled with respect to the normal plane (P) of the center line (A) of the punch tool such that the bevel angle (α) is greater than 0°, whereby the curved tip (3a) of the cutting blade penetrates the pipe first from the side of the pipe during the punch.

7. The device according to claim 5, characterized in that the bevel angle (α) of the cutting blade (3) with respect to the normal plane (P) of the center line (A) of the punch tool is between 5° and 30°.

8. The device according to claim 6, characterized in that the cutting blade (3) of the punch tool (1) has a curved tip (3a) and straight cutting edges on both sides thereof, and in that the angle (β1) between the straight cutting edges of the cutting blade (3) on opposite sides of the curved tip (3a) of the cutting blade is between 97 and 107° as seen in the direction of the longitudinal axis (A) of the punch tool.

9. The device according to claim 5, characterized in that the punch tool (1) has a trough-like blade body (2) ending in a cutting blade (3), and in that the outer surface of the blade body (2) has two planar sides (18) ending in the straight cutting edges of the cutting blade.

10. The device according to claim 5, characterized in that the wall thickness of the blade body (2) increases when moving from the cutting blade (3) towards the base of the blade body (2), and in that the base of the blade body (2) ends in a relieving pit (15) receiving the piece removed from the main pipe.

11. The device according to claim 5, characterized in that the inner support (9) is arranged to be moved to and from the supporting position by a single actuator (F) arranged to first move the inner support (9) along with its wedge (11) to the supporting position via a wedge arm (11a) and a spring (14), and then to move only the wedge (11) via the wedge arm (11a) against the force of said spring (14) when the inner support is retained in the supporting position, where-by the inner support (9) is wedged into the supporting position.
